(19) United States
(12) Patent Application Publication
(10) Pub. No.: US 2010/0225887 A1
(43) Pub. Date: Sep. 9, 2010

(54) PROJECTOR ADJUSTMENT METHOD, PROJECTOR, AND PROJECTOR ADJUSTMENT SYSTEM

(75) Inventors: Kaori SATO, Shiojiri-shi (JP); Hiroshi HASEGAWA, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/710,760

(22) Filed: Feb. 23, 2010

(30) Foreign Application Priority Data
Mar. 4, 2009 (JP) 2009-050329

(51) Int. Cl. G03B 21/00

(52) U.S. Cl. 353/31

(57) ABSTRACT

A method for adjusting a projector that modulates a plurality of types of color light based on image information to project an image, includes: acquiring first captured image data by using a capturing device to capture a first projected image projected with an optical filter that removes predetermined spectral components not disposed in an optical path inside or outside the projector; acquiring second captured image data by using the capturing device to capture a second projected image projected with the optical filter disposed in the optical path; calculating an adjustment parameter for adjusting the projector based on the first and second captured image data; and adjusting the projector based on the adjustment parameter calculated in the adjustment parameter calculation.

### BACKGROUND

1. Technical Field

The present invention relates a projector adjustment method, a projector, and a projector adjustment system.

2. Related Art

Projectors as projection-type image display apparatus, which in recent years have had higher image quality and have been produced at lower cost, have been used in a variety of applications. Therefore, the color reproducibility and image quality of a projector have been more important factors depending on the application in which the projector is used. Since an image projected by a projector suffers from color unevenness, brightness unevenness, and other individual differences, it is important to precisely improve the image quality of an image projected by a projector.

To adjust the image quality of an image projected by a projector, the projected image is measured by using multiband measurement (multiband imaging), and the measurement result is incorporated in the projector. JP-A-2005-20581, for example, discloses an example of the multiband measurement.

JP-A-2005-20581 discloses a technology in which an offset image produced from a black signal level successively undergoes multiband measurement for each of a plurality of primary colors by changing band-pass filters corresponding to the primary colors to calculate correction data for a projector. That is, in JP-A-2005-20581, the multiband measurement is performed by attaching the band-pass filters corresponding to the plurality of primary colors to the camera, which is the imaging-side (measurement-side) apparatus.

The multiband measurement disclosed in JP-A-2005-20581, for example, allows the image quality of an image projected by a projector to be further improved by measuring the color of the projected image more accurately.

In the technology disclosed in JP-A-2005-20581, however, exchanging the filter attached to the camera is disadvantageously a cumbersome task. Further, exchanging the filter displaces the camera, disadvantageously resulting in shift in the captured image and hence reduction in precision in the measured color of the projected image. To solve the above problem, it is necessary to use a complicated mechanism for attaching the filter to the camera, resulting in increased cost.

Further, to measure the color of the projected image more accurately, it is necessary to increase the number of bands used in the multiband measurement. To this end, for example, the technology disclosed in JP-A-2005-20581 is used. In this case, however, the cost is disadvantageously further increased.

Moreover, attaching a filter to the camera causes slight refraction due to the thickness of the filter. It is therefore necessary to incorporate the measurement result in the projector in consideration of the refraction due to the thickness, which complicates the analysis of the measurement result.

### SUMMARY

An advantage of some aspects of the invention is to provide a projector adjustment method, a projector, a projector adjustment system, and a projector adjustment program that allow an image to be adjusted more accurately at a low cost by using multiband measurement.

1. An aspect of the invention is a method for adjusting a projector that modulates a plurality of types of color light based on image information to project an image, the method including acquiring first captured image data by using a capturing device to capture a first projected image projected with an optical filter that removes predetermined spectral components not disposed in an optical path inside or outside the projector, acquiring second captured image data by using the capturing device to capture a second projected image projected with the optical filter disposed in the optical path, calculating an adjustment parameter for adjusting the projector based on the first and second captured image data, and adjusting the projector based on the adjustment parameter calculated in the adjustment parameter calculation.

According to the present aspect, the first captured image data are acquired by capturing the first projected image projected with the optical filter not disposed in the optical path of the projector. The second captured image data are acquired by capturing the second projected image projected with the optical filter disposed in the optical path. The adjustment parameter for adjusting the projector is calculated based on the first and second captured image data. Therefore, the number of bands can be increased at a low cost in multiband measurement. Further, since it is not necessary to provide any optical filter on the side of the capturing device, the capturing device will not be displaced due to an optical filter attaching operation, and the mechanism for attaching the capturing device can be simplified. Moreover, no discrepancy in image position will occur between the state in which the optical filter is attached and the state in which the optical filter is detached, and the adjustment parameter for adjusting the projector can be calculated without consideration of the refraction resulting from the thickness of the optical filter.

2. In the method for adjusting a projector according to another aspect of the invention, the adjustment parameter is calculated in the adjustment parameter calculation, provided that the first and second captured image data are acquired by using bands the number of which is greater than the number of bands used in the capturing device.

According to the present aspect, it is not necessary to prepare an expensive multiband capturing device, but the number of bands can be increased at a low cost in multiband measurement.

3. In the method for adjusting a projector according to another aspect of the invention, the adjustment parameter calculation includes estimating the spectral distribution associated with the projector based on the first and second captured image data and the spectral sensitivity characteristics of the capturing device, and converting the spectral distribution estimated in the estimation into color coordinates in a predetermined color space, and the adjustment parameter is calculated based on the color coordinates obtained in the conversion.

According to the present aspect, the color of a projected image can be measured more accurately at a low cost independently of projector-to-projector difference. As a result, the quality of an image projected by the projector can be adjusted more precisely.

4. In the method for adjusting a projector according to another aspect of the invention, the adjustment parameter calculation includes estimating the spectral distribution associated with the projector based on the first and second captured image data, and converting the spectral distribution estimated in the estimation into color coordinates in a predetermined color space, and the adjustment parameter is calculated based on the color coordinates obtained in the conversion.

According to the present aspect, the quality of an image projected by the projector can be adjusted precisely when the spectral sensitivity characteristics of the capturing device are known.

5. In the method for adjusting a projector according to another aspect of the invention, the image information corresponding to the first projected image is the same as the image information corresponding to the second projected image.

According to the present aspect, since the first and second captured image data are used to precisely increase the number of bands used in the multiband measurement, the quality of an image projected by the projector can be adjusted precisely.

6. In the method for adjusting a projector according to another aspect of the invention, at least one of the luminance and chromaticity of the entire projected image is adjusted in the adjustment of the projector based on the adjustment parameter.

According to the present aspect, the quality of an image projected by the projector can be adjusted precisely.

7. Another aspect of the invention is a projector that modulates a plurality of types of color light based on image information to project an image, the projector including a projection unit including a light source, a light modulation device that modulates the plurality of types of color light contained in the light flux emitted from the light source based on the image information, and a projection lens that projects the light modulated by the light modulation device, an optical filter detachably provided in an optical path inside or outside the projection unit, the optical filter removing predetermined spectral components, and an capturing device that captures an image projected by the projection unit. The capturing device acquires first captured image data by capturing a first projected image projected with the optical filter not disposed in the optical path inside or outside the projection unit and acquires second captured image data by capturing a second projected image projected with the optical filter disposed in the optical path.

According to the present aspect, the first captured image data are acquired by capturing the first projected image projected with the optical filter not disposed in the optical path of the projector. The second captured image data are acquired by capturing the second projected image projected with the optical filter disposed in the optical path. The adjustment parameter for adjusting the projector is calculated based on the first and second captured image data. Therefore, the number of bands can be increased at a low cost in multiband measurement. Further, since it is not necessary to provide any optical filter on the side of capturing device, the capturing device will not be displaced due to an optical filter attaching operation, and the mechanism for attaching the capturing device can be simplified. Moreover, no discrepancy in image position will occur between the state in which the optical filter is attached and the state in which the optical filter is detached, and the adjustment parameter for adjusting the projector can be calculated without consideration of the refraction resulting from the thickness of the optical filter.

8. In the projector according to another aspect of the invention, at least one of the luminance and chromaticity of the entire projected image is adjusted based on the first and second captured image data.

According to the present aspect, a projector capable of precisely adjusting the quality of a projected image is provided.

9. Another aspect of the invention is a projector adjustment system for adjusting a projector that modulates a plurality of types of color light based on image information to project an image, the system including the projector described above and an image adjustment apparatus that adjusts an image projected by the projector. The image adjustment apparatus includes a captured image data analyzer that analyzes the first and second captured image data, and an adjustment parameter calculator that calculates an adjustment parameter for adjusting the projector based on the analysis result obtained from the captured image data analyzer. The image projected by the projector is adjusted based on the adjustment parameter.

According to the present aspect, the first captured image data are acquired by capturing the first projected image projected with the optical filter not disposed in the optical path of the projector. The second captured image data are acquired by capturing the second projected image projected with the optical filter disposed in the optical path. The adjustment parameter for adjusting the projector is calculated based on the first and second captured image data. Therefore, the number of bands can be increased at a low cost in multiband measurement. Further, since it is not necessary to provide any optical filter on the side of the capturing device, the capturing device will not be displaced due to an optical filter attaching operation, and the mechanism for attaching the capturing device can be simplified. Moreover, no discrepancy in image position will occur between the state in which the optical filter is attached and the state in which the optical filter is detached, and the adjustment parameter for adjusting the projector can be calculated without consideration of the refraction resulting from the thickness of the optical filter.

10. In the projector adjustment system according to another aspect of the invention, the adjustment parameter calculator calculates the adjustment parameter, provided that the first and second captured image data are acquired by using bands the number of which is greater than the number of bands used in the capturing device.

According to the present aspect, a projector adjustment system that requires no expensive multiband capturing device but can perform multiband measurement with an increased number of bands at a low cost is provided.

11. In the projector adjustment system according to another aspect of the invention, the captured image data analyzer estimates the spectral distribution associated with the projector based on the first and second captured image data and the spectral sensitivity characteristics of the capturing device, and converts the estimated spectral distribution into color coordinates in a predetermined color space, and the adjustment parameter calculator calculates the adjustment parameter based on the color coordinates converted by the captured image data analyzer.

According to the present aspect, a projector adjustment system capable of precisely adjusting the quality of an image projected by the projector when the spectral sensitivity characteristics of the capturing device are known is provided.

12. In the projector adjustment system according to another aspect of the invention, the captured image data analyzer estimates the spectral distribution associated with the projector based on the first and second captured image data, and converts the estimated spectral distribution into color coordinates in a predetermined color space, and the adjustment parameter calculator calculates the adjustment parameter based on the color coordinates converted by the captured image data analyzer.

According to the present aspect, a projector adjustment system capable of precisely adjusting the quality of an image projected by the projector when the spectral sensitivity characteristics of the capturing device are known is provided.

13. In the projector adjustment system according to another aspect of the invention, the image information corresponding to the image projected by using the light that has passed through the optical filter is the same as the image information corresponding to the image projected by using the light that has not passed through the optical filter.

According to the present aspect, since the captured image data obtained when the optical filter is detached and the captured image data obtained when the optical filter is attached are used to precisely increase the number of bands used in the multiband measurement, the quality of an image projected by the projector can be adjusted precisely.

14. In the projector adjustment system according to another aspect of the invention, the projector adjusts at least one of the luminance and chromaticity of the entire projected image based on the adjustment parameter.

According to the present aspect, the quality of an image projected by the projector can be adjusted precisely.

### BRIEF DESCRIPTION OF THE DRAWINGS

The invention will now be described with reference to the accompanying drawings, wherein like numbers refer to like elements.

FIG. 1 shows an exemplary configuration of a projector adjustment system in a first embodiment according to the invention.

FIGS. 2A and 2B describe the number of bands used in a capturing device in the first embodiment.

FIG. 3 is a block diagram showing an exemplary configuration of the projector adjustment system shown in FIG. 1.

FIG. 4 is a block diagram showing an exemplary configuration of a captured image data analyzer shown in FIG. 3.

FIG. 5 describes the operation of a color space converter.

FIG. 6 describes the operation of an adjustment parameter calculator.

FIG. 7 describes a specific process carried out in the adjustment parameter calculator.

FIG. 8 is a block diagram showing an exemplary configuration of a luminance/chromaticity adjuster shown in FIG. 3.

FIG. 9 shows an exemplary configuration of a projection unit shown in FIG. 3.

FIG. 10 describes the operation of the projector adjustment system in the first embodiment.

FIG. 11 is a block diagram showing an exemplary hardware configuration of an image adjustment apparatus in the first embodiment.

FIG. 12 shows a flowchart of exemplary processes carried out by the image adjustment apparatus in the first embodiment.

FIG. 13 shows an exemplary configuration of a projection unit in a third embodiment according to the invention.

FIG. 14 shows an exemplary configuration of a projection unit in a fourth embodiment according to the invention.

FIG. 15 shows an exemplary configuration of a projection unit in a fifth embodiment according to the invention.

FIG. 16 shows an exemplary configuration of a projection unit in a sixth embodiment according to the invention.

FIG. 17 is an exemplary perspective view showing an exterior key portion of a projector in a seventh embodiment according to the invention.

### DESCRIPTION OF EXEMPLARY EMBODIMENTS

Embodiments of the invention will be described below in detail with reference to the drawings. The embodiments described below are not intended to unreasonably limit the scope of the invention set forth in the claims. Further, the configurations described below are not necessarily essential to achieve the advantage of the invention.

### First Embodiment

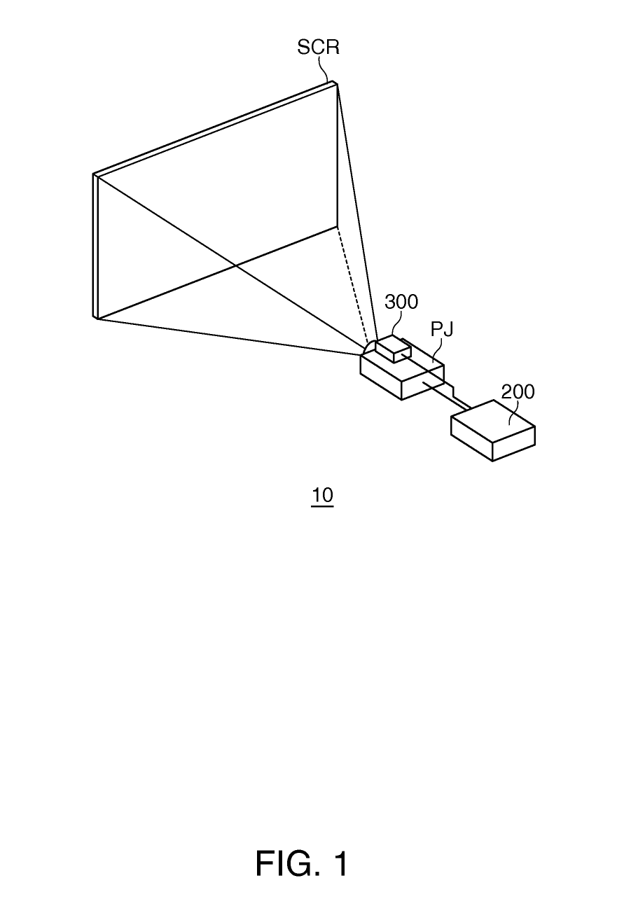

FIG. 1 shows an exemplary configuration of a projector adjustment system in a first embodiment according to the invention.

A projector adjustment system 10 in the first embodiment includes a projector PJ as an image display apparatus (image projection apparatus) and an image adjustment apparatus 200. The projector PJ includes a capturing device (camera) 300 and projects an image on a screen SCR as a projection surface. While the first embodiment will be described by assuming that the projector PJ houses the capturing device 300, the capturing device 300 may be provided external to the projector PJ.

The capturing device 300 can perform multiband measurement by acquiring captured image data on an image projected on the screen SCR by the projector PJ in RGB multiple bands (three bands). The captured image data acquired by the capturing device 300 are outputted to the image adjustment apparatus 200.

The image adjustment apparatus 200 is connected to the projector PJ and the capturing device 300 and capable of controlling the projector PJ and the capturing device 300. More specifically, the image adjustment apparatus 200 adjusts the image quality of an image projected by the projector PJ based on the captured image data (measurement results) from the capturing device 300, which captures the image projected by the projector PJ. The image adjustment apparatus 200 can send to the projector PJ adjustment parameters calculated based on the captured image data from the capturing device 300. The projector PJ can adjust the luminance and chromaticity of the entire screen based on adjustment parameters. The function of the image adjustment apparatus 200 described above is achieved, for example, by software processing using a personal computer or any other suitable component or hardware processing using dedicated hardware or any other suitable component.

In the first embodiment, to precisely improve the image quality of an image projected by the projector PJ, the number of bands used in the multiband measurement performed by the capturing device 300 is virtually increased, whereby the color of the projected image is more accurately measured at a low cost. To this end, an optical filter that removes predetermined spectral components is detachably provided in the optical path of the projector PJ, whereby 6-band multiband measurement is virtually achieved by attaching or detaching the optical filter. It is assumed that the removal function of the optical filter is achieved by reflection or absorption of unwanted light having predetermined spectral components.

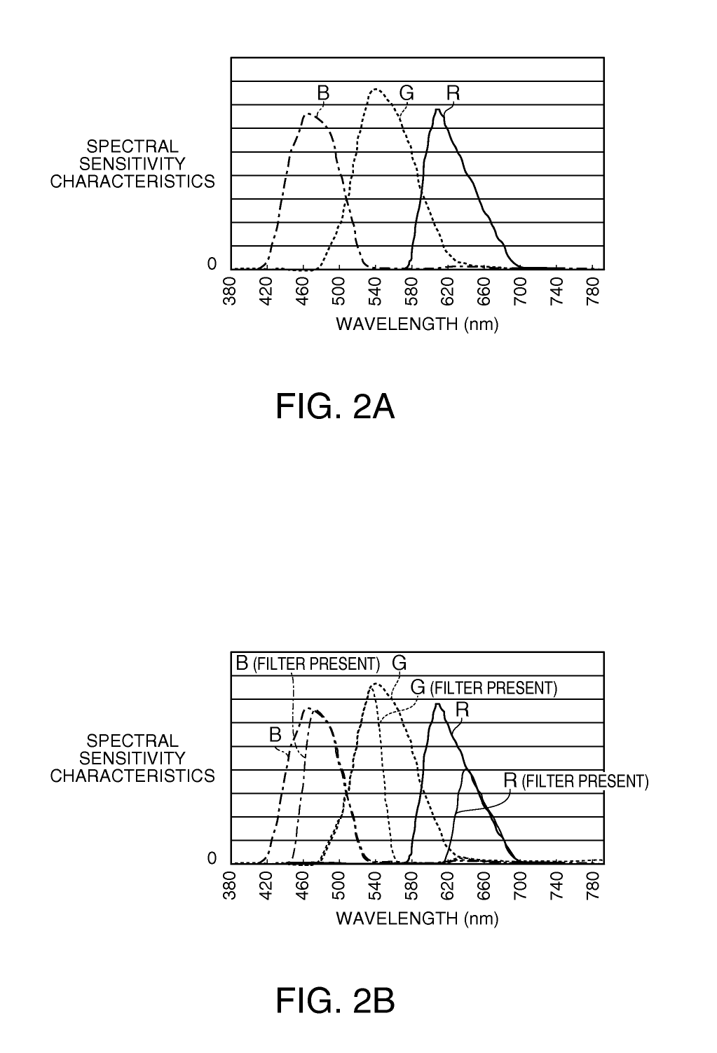

FIGS. 2A and 2B describe the number of bands used in the capturing device 300 in the first embodiment. FIG. 2A shows an example of the spectral sensitivity characteristics of the bands used in the capturing device 300. FIG. 2B shows an example of the spectral sensitivity characteristics obtained when an image projected by the projector PJ is captured by the capturing device 300 with the optical filter disposed in the optical path as well as the spectral sensitivity characteristics shown in FIG. 2A.

In FIGS. 2A and 2B, the horizontal axis represents the wavelength of light, and the vertical axis represents the spectral sensitivity. The RGB three bands used in the capturing device 300 have the spectral sensitivity characteristics shown in FIG. 2A. The capturing device 300 having the spectral sensitivity characteristics shown in FIG. 2A is commercially available at a relatively low cost. Disposing and not disposing an optical filter in the optical path of the projector PJ produces a state in which the optical filter is disposed in the optical path (the optical filter is attached) and a state in which the optical filter is not disposed in the optical path (the optical filter is detached), and the spectral sensitivity characteristics in the two states are defined for each of the bands used in the capturing device 300, whereby the 3-band capturing device 300 can virtually perform 6-band multiband measurement.

The optical filter described above can be a filter that removes (reflects or absorbs) the light having wavelength bands from ultraviolet to 440 nm and from 550 to 630 nm, as shown in FIG. 2B. In FIG. 2B, for example, when the optical filter is disposed in the optical path, the spectral sensitivity characteristics are nearly “0” for the light having wavelength bands from ultraviolet to 440 nm and from 550 to 630 nm in each of the bands used in the capturing device 300. As described above, disposing and not disposing the optical filter in the optical path of the projector PJ allows not only the spectral sensitivity characteristics in the bands used in the capturing device 300 shown in FIG. 2A to be obtained but also the spectral sensitivity characteristics in the bands in the state in which the optical filter is disposed in the optical path to be obtained, for example, as shown in FIG. 2B.

According to the first embodiment, it is therefore not necessary to prepare an expensive multiband capturing device, but the number of bands can be increased at a low cost in multiband measurement. Further, since it is not necessary to provide any optical filter on the capturing device side, the capturing device will not be displaced due to an optical filter attaching operation, and the mechanism for attaching the capturing device can be simplified.

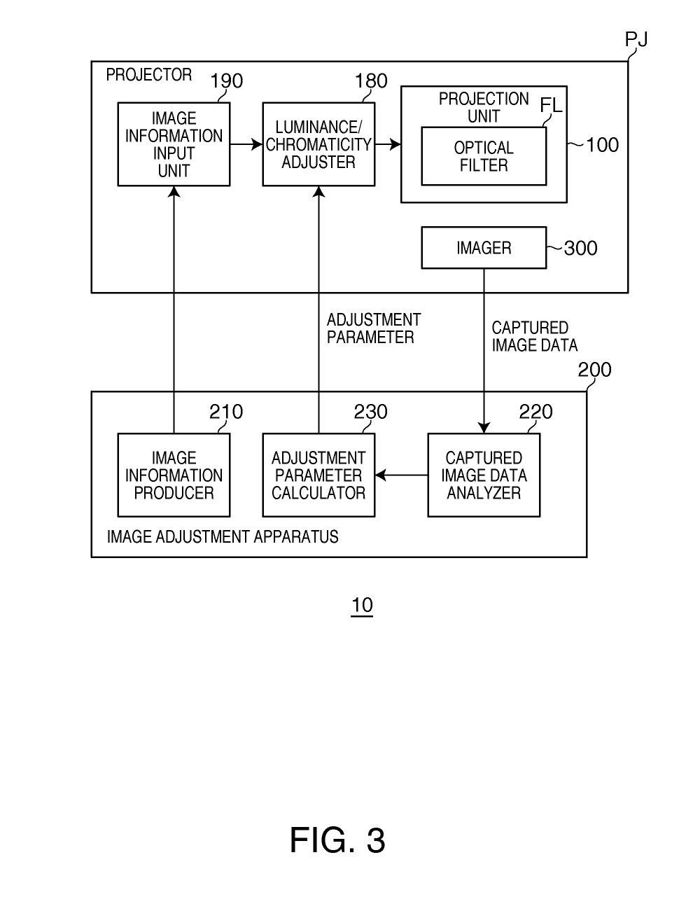

FIG. 3 is a block diagram showing an exemplary configuration of the projector adjustment system 10 shown in FIG. 1. In FIG. 3, the portions that are the same as those in FIG. 1 have the same reference characters, and no description of these portions will be made as appropriate.

The image adjustment apparatus 200 includes an image information producer 210, a captured image data analyzer 220, and an adjustment parameter calculator 230.

The image information producer 210 produces image information corresponding to content images and outputs the image information to the projector PJ. The function of the image information producer 210 may alternatively be provided external to the image adjustment apparatus 200.

The captured image data analyzer 220 analyzes captured image data on a projected image acquired by the capturing device 300 to calculate the spectral distribution associated with the projector PJ and converts the spectral distribution into color coordinates in a predetermined color space to produce conversion information. The adjustment parameter calculator 230 then calculates adjustment parameters for adjusting the projector PJ based on the conversion information.

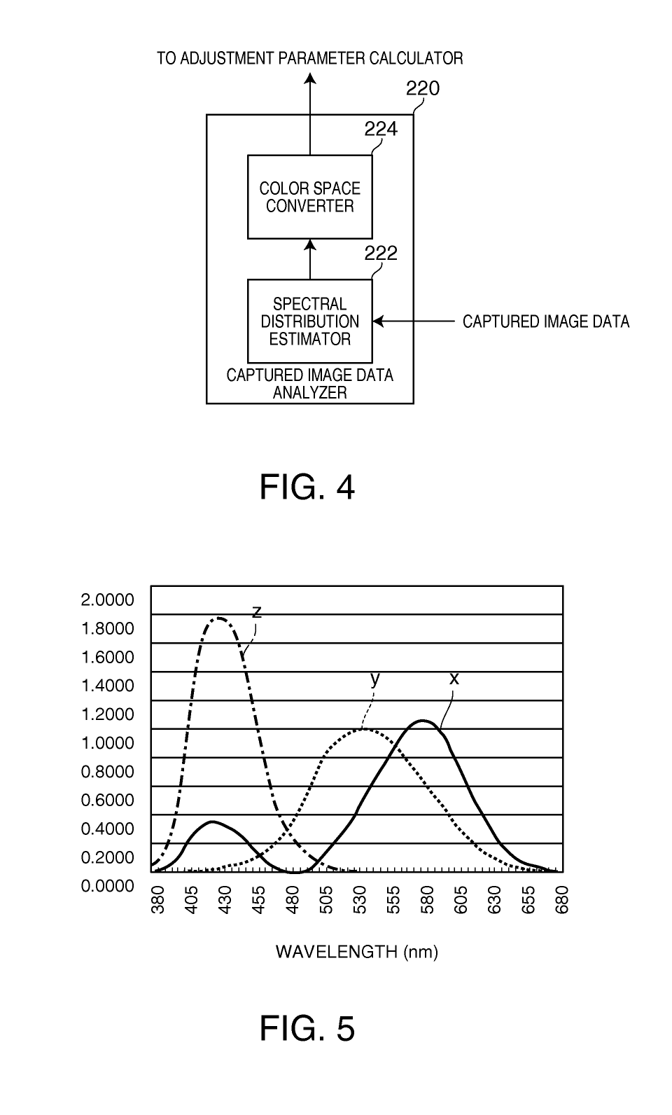

FIG. 4 is a block diagram showing an exemplary configuration of the captured image data analyzer 220 shown in FIG. 3. In FIG. 4, the portions that are the same as those in FIG. 3 have the same reference characters, and no description of these portions will be made as appropriate.

The captured image data analyzer 220 includes a spectral distribution estimator 222 and a color space converter 224.

The spectral distribution estimator 222 uses the captured image data from the capturing device 300 to estimate the spectral distribution associated with the projector PJ. To allow the spectral distribution estimator 222 to determine the spectral distribution associated with the projector PJ, it is necessary to prepare information on the spectral distribution of external illumination, the spectral reflectance of the screen SCR, and the spectral sensitivity characteristics of the capturing device 300. In the first embodiment, it is assumed that the screen SCR shows uniform reflection characteristics in a dark room, and the spectral distribution estimator 222 estimates the spectral distribution associated with the projector PJ based on the captured image data from the capturing device 300 and the spectral sensitivity characteristics of the capturing device 300 that have been measured in advance.

To estimate the spectral distribution associated with the projector PJ, for example, the estimation method described in the following Reference Literature 1 can be used: “Introduction to spectral image processing” edited by Yoichi Miyake, Chapter 4, Spectral Reflectance Estimation Theory, University of Tokyo Press, pp. 63-84. Reference Literature 1 describes that the spectral distribution obtained when the light from a projector is reflected off a screen can be estimated from captured image data obtained in multiband measurement using a small number of bands based on an estimation method using a minimum norm solution and a primary component, a minimum mean squared error law, or any other suitable method.

In the first embodiment, it is assumed that the captured image data from the capturing device 300, the number of bands of which is “3”, are 6-band captured image data obtained by attaching and detaching an optical filter. In this case, the captured image data g is expressed by a 6×1 matrix. When the number of wavelength sampling operations is L, the spectral sensitivity characteristics of the capturing device 300 that have been measured in advance are expressed by an L×6 matrix. Now, let E be the spectral distribution (L×L matrix) associated with the projector PJ, r be the spectral reflectance (L×1 matrix) of the screen SCR, and n be noise (6×1 matrix). The captured image data g is expressed by the following equation:

g=S^{t}·E·r+n (1)

In the above equation, S is a matrix representing the spectral distribution (L×6 matrix) associated with the capturing device 300. In the matrix S (=[s₁, s₂, . . . , s₆]), the i-th column sᵢ represents the spectral sensitivity characteristics in the i-th band. Sₜ is the transposed matrix of the matrix S.

Now, a solution whose norm is the least in the solution space is selected, and it is assumed that a noise-free condition is satisfied (i.e., n=0). In this case, the captured image data g is expressed as follows:

g=S^{t}·E·r (2)

Since it is assumed that the screen SCR shows uniform reflection characteristics, the spectral reflectance of the screen SCR r is a matrix whose each element is “1”. Therefore, the following equation is obtained:

g=S^{t}·E (3)

As described in Reference Literature 1, for example, the following equation is derived from the equation (3):

E=S·(S^{t}·S)⁻¹·g (4)

Therefore, when the spectral sensitivity characteristics of the capturing device 300 is known and captured image data can be acquired from the capturing device 300, the spectral distribution associated with the projector PJ can be estimated.

The color space converter 224 shown in FIG. 4 converts the spectral distribution associated with the projector PJ that has been estimated by the spectral distribution estimator 222 into color coordinates in a predetermined color space and outputs the conversion result to the adjustment parameter calculator 230.

FIG. 5 describes the operation of the color space converter 224. In FIG. 5, the horizontal axis represents the wavelength of light, and the vertical axis represents the spectral response. FIG. 5 shows an example of a color matching function representing the spectral response corresponding to human eyes.

The color space converter 224 outputs values in a CIE (Commission Internationale de l'Eclairage) colorimetric system corresponding to the spectral distribution associated with the projector PJ that has been estimated by the spectral distribution estimator 222. More specifically, the color space converter 224 outputs values in the XYZ colorimetric system (CIE 1931 colorimetric system) corresponding to the spectral distribution associated with the projector PJ to the adjustment parameter calculator 230. The color space converter 224 therefore weights the spectral distribution associated with the projector PJ that has been estimated by the spectral distribution estimator 222 in accordance with the color matching function shown in FIG. 5, sums the weighted spectral distributions, and outputs values in the XYZ colorimetric system as conversion information.

Values in a CIE colorimetric system described above are not limited to values in the XYZ colorimetric system but may be values in the X₁₀Y₁₀Z₁₀ colorimetric system (CIE 1964 colorimetric system), chromaticity coordinates (x, y) in the XYZ colorimetric system, chromaticity coordinates (x₁₀, y₁₀) in the X₁₀Y₁₀Z₁₀ colorimetric system, the lightness and color coordinates in the CIELAB color space (CIE 1976 L*a*b* color space), or the lightness and color coordinates in the CIELUV color space (CIE 1976 L*u*v* color space).

As described above, the captured image data analyzer 220 can analyze captured image data acquired by the capturing device 300 to produce values in the XYZ colorimetric system capable of quantitative representation independent of the difference in the spectral characteristics of the projector PJ.

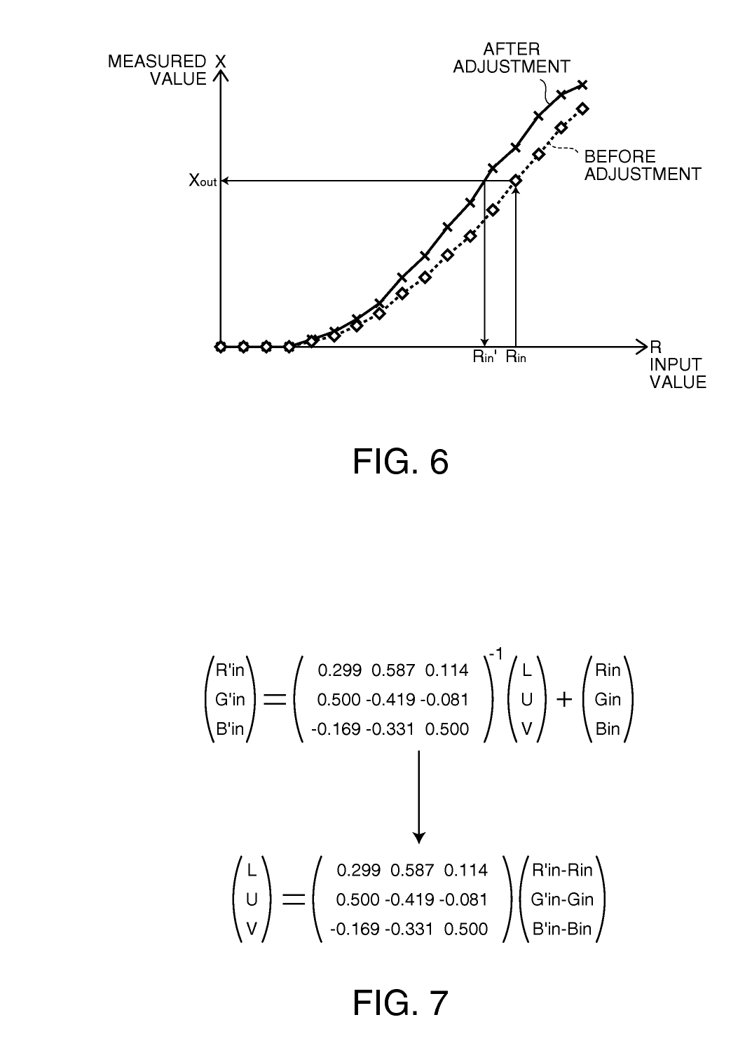

FIG. 6 describes the operation of the adjustment parameter calculator 230. FIG. 6 shows an example of how a value X_{R} in the XYZ colorimetric system for an input value of the R component of image information changes before and after the projector PJ is adjusted by using an adjustment parameter. The behavior shown in FIG. 6 also applies to how a value Y_{G} in the XYZ colorimetric system for an input value of the G component of the image information changes before and after the projector PJ is adjusted and how a value X_{B} in the XYZ colorimetric system for an input value of the G component of the image information changes.

FIG. 7 describes a specific process carried out in the adjustment parameter calculator 230.

The adjustment parameter calculator 230 in the first embodiment calculates an input value Rin′ of the R component from the projector PJ in such a way that the measured value for an input value Rin of the R component of the image information coincides with a predetermined reference value Xout. The adjustment parameter calculator 230 then determines an adjustment parameter for correction in such a way that the input value Rin′ is outputted when the input value of the R component of the image information is Rin, and outputs the adjustment parameter to the projector PJ.

The adjustment parameters are determined by modifying the conversion equation, for example, shown in FIG. 7 as the lightness and color coordinates (L, U, V) in the CIELUV color space of an image projected by the projector PJ, the lightness and color coordinates corresponding to the input value Rin of the R component, the input value Gin of the G component, and the input value Bin of the B component. Therefore, the adjustment parameters for providing the lightness and color coordinates may be outputted to the projector PJ.

As described above, after the estimated spectral distribution associated with the projector PJ is converted into color coordinates in a predetermined color space, the adjustment parameter calculator 230 calculates adjustment parameters to be used to adjust the lightness and chromaticity of the entire projected image.

The thus calculated adjustment parameters are outputted to the projector PJ. The configuration of the projector PJ will now be described below.

As shown in FIG. 3, the projector PJ includes a projection unit 100 as an image display unit, a luminance/chromaticity adjuster 180 as an image processor, and an image information input unit 190.

The projection unit 100 includes an optical filter FL that can be disposed in the optical path provided in the projection unit 100, and can project an image while switching the projection state between a state in which the optical filter is disposed in the optical path (a state in which the optical filter FL is attached) and a state in which the optical filter is not disposed in the optical path (a state in which the optical filter FL is detached). The projection unit 100 projects an image that does not contain the light removed by the optical filter FL when the optical filter FL is attached, whereas projecting an image that also contains the light to be removed by the optical filter FL when the optical filter FL is detached.

The image information input unit 190 carries out a reception interface process of receiving image information from the image adjustment apparatus 200 and outputs the image information on an input image to the luminance/chromaticity adjuster 180. The reception interface process can include a physical layer signal level conversion process and a progressive conversion process.

The luminance/chromaticity adjuster 180 corrects at least one of the luminance and the chromaticity corresponding to the image information from the image information input unit 190 based on the adjustment parameters from the image adjustment apparatus 200, and outputs the corrected image information to the projection unit 100.

The projection unit 100 changes the rate at which the light from a light source (not shown) is modulated based on the image information having been adjusted (corrected) by the luminance/chromaticity adjuster 180, and projects the modulated light on the screen SCR. More specifically, the projection unit 100 projects an image by modulating multiple types of color light emitted from the light source based on the image information from the luminance/chromaticity adjuster 180.

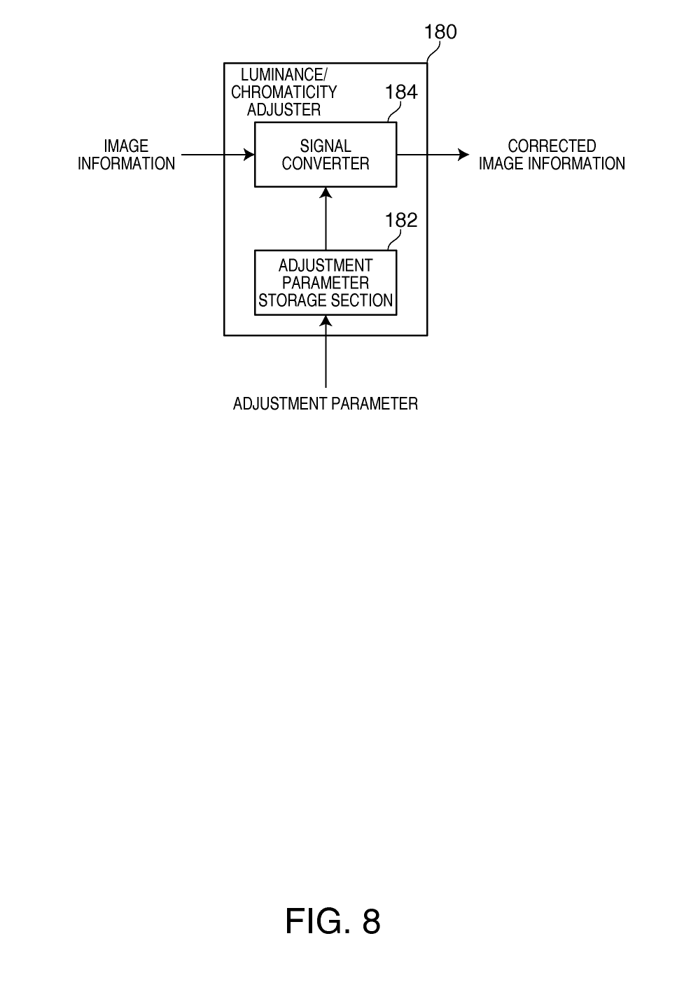

FIG. 8 is a block diagram showing an exemplary configuration of the luminance/chromaticity adjuster 180 shown in FIG. 3. In FIG. 8, the portions that are the same as those in FIG. 3 have the same reference characters, and no description of these portions will be made as appropriate.

The luminance/chromaticity adjuster 180 includes an adjustment parameter storage section 182 and a signal converter 184. The luminance/chromaticity adjuster 180 receives the adjustment parameters calculated by the adjustment parameter calculator 230 in the image adjustment apparatus 200, and the adjustment parameter storage section 182 stores the inputted adjustment parameters. The signal converter 184 corrects the image information from the image information input unit 190 based on the adjustment parameters stored in the adjustment parameter storage section 182 and outputs the corrected image information to the projection unit 100.

For example, the adjustment parameter storage section 182 stores adjustment parameters for all grayscales that the image information can express, and the signal converter 184 can correct the pre-correction image information based on the adjustment parameters corresponding to the grayscales specified by the image information. Alternatively, for example, the adjustment parameter storage section 182 stores adjustment parameters for discrete ones of all grayscales that the image information can express, and the signal converter 184 can correct the pre-correction image information based on the adjustment parameters corresponding to the grayscales specified by the image information or the adjustment parameters obtained by interpolating the adjustment parameters stored in the adjustment parameter storage section 182.

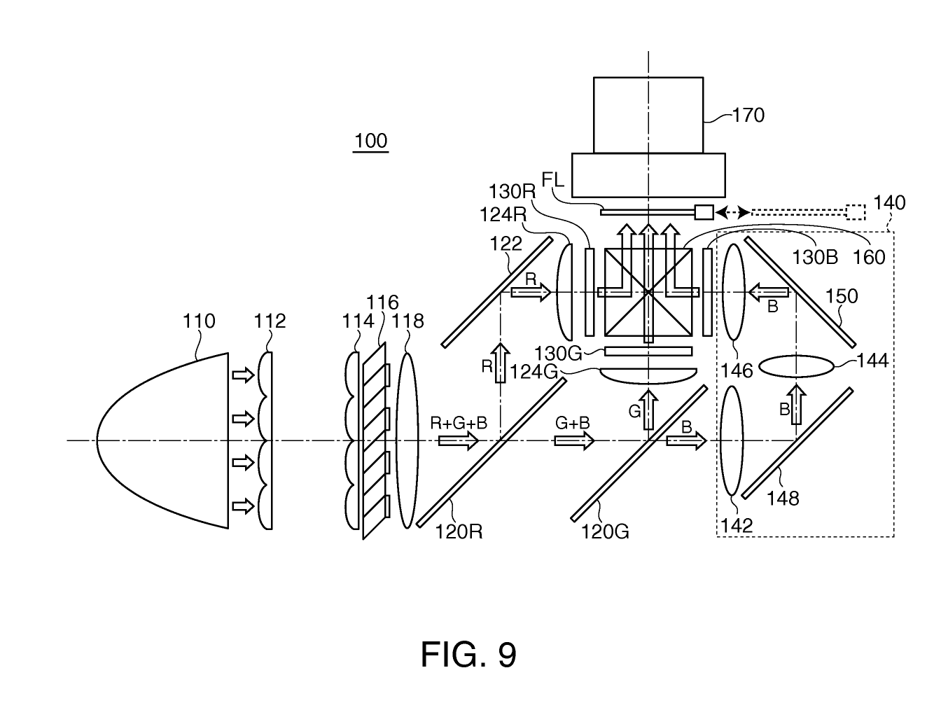

FIG. 9 shows an exemplary configuration of the projection unit 100 shown in FIG. 3. The projection unit 100 of the projector PJ shown in FIG. 9 has what is called a three-panel configuration, but the projection unit according to an aspect of the invention does not necessarily have what is called a three-panel configuration.

The projection unit 100 includes a light source 110, integrator lenses 112 and 114, a polarization conversion element 116, a superimposing lens 118, a dichroic mirror for the R component 120R, a dichroic mirror for the G component 120G, a reflection mirror 122, a field lens for the R component 124R, a field lens for the G component 124G, a liquid crystal panel for the R component 130R (first light modulation device), a liquid crystal panel for the G component 130G (second light modulation device), a liquid crystal panel for the B component 130B (third light modulation device), a relay system 140, across dichroic prism 160, the optical filter FL, and a projection lens 170. The liquid crystal panels used as the liquid crystal panel for the R component 130R, the liquid crystal panel for the G component 130G, and the liquid crystal panel for the B component 130B are transmissive liquid crystal display devices. The relay system 140 includes relay lenses 142, 144, and 146 and reflection mirrors 148 and 150.

The light source 110 is formed of an ultra-high pressure mercury lamp or any other suitable lamp and emits light containing at least R component light, G component light, and B component light. The integrator lens 112 includes a plurality of lenslets for dividing the light from the light source 110 into a plurality of segmented light fluxes. The integrator lens 114 includes a plurality of lenslets corresponding to the plurality of lenslets in the integrator lens 112. The superimposing lens 118 superimposes the segmented light fluxes having exited through the plurality of lenslets in the integrator lens 114 on the liquid crystal panels.

The polarization conversion element 116 includes a polarizing beam splitter array and a λ/2 plate and converts the light from the light source 110 into substantially one type of polarized light. The polarizing beam splitter array has a structure in which a polarization separating layer and a reflection layer are alternately arranged, each of the polarization separating layers separating the segmented light fluxes divided by the integrator lens 112 into p-polarized light and s-polarized light, each of the reflection layers changing the direction of the light from the corresponding polarization separating layer. The two types of polarized light separated by the polarization separating layers pass through the λ/2 plate, where the polarization directions of the polarized light are aligned. The substantially one type of polarized light converted by the polarization conversion element 116 is incident on the superimposing lens 118.

The light having passed through the superimposing lens 118 is incident on the dichroic mirror for the R component 120R. The dichroic mirror for the R component 120R has a function of reflecting the R component light whereas transmitting the G component light and the B component light. The light having passed through the dichroic mirror for the R component 120R is incident on the dichroic mirror for the G component 120G, whereas the light reflected off the dichroic mirror for the R component 120R is reflected off the reflection mirror 122 and guided to the field lens for the R component 124R.

The dichroic mirror for the G component 120G has a function of reflecting the G component light whereas transmitting the B component light. The light having passed through the dichroic mirror for the G component 120G is incident on the relay system 140, whereas the light reflected off the dichroic mirror for the G component 120G is guided to the field lens for the G component 124G.

To reduce the difference in the optical path length as much as possible between the B component light passing through the dichroic mirror for the G component 120G and the other R and G component light, the relay lenses 142, 144, and 146 in the relay system 140 are used to correct the difference in the optical path length. The light having passed through the relay lens 142 is reflected off the reflection mirror 148 and guided to the relay lens 144. The light having passed through the relay lens 144 is reflected off the reflection mirror 150 and guided to the relay lens 146. The light having passed through the relay lens 146 is incident on the liquid crystal panel for the B component 130B.

The light incident on the field lens for the R component 124R is converted into parallelized light and incident on the liquid crystal panel for the R component 130R. The liquid crystal panel for the R component 130R functions as a light modulation device (light modulator), and the transmittance (transmission rate, modulation rate) thereof is changed based on image information on the R component. Therefore, the light incident on the liquid crystal panel for the R component 130R (first color component light) is modulated based on the image information on the R component having been corrected by the luminance/chromaticity adjuster 180, and the modulated light is incident on the cross dichroic prism 160.

The light incident on the field lens for the G component 124G is converted into parallelized light and incident on the liquid crystal panel for the G component 130G. The liquid crystal panel for the G component 130G functions as a light modulation device (light modulator), and the transmittance (transmission rate, modulation rate) thereof is changed based on image information on the G component. Therefore, the light incident on the liquid crystal panel for the G component 130G (second color component light) is modulated based on the image information on the G component having been corrected by the luminance/chromaticity adjuster 180, and the modulated light is incident on the cross dichroic prism 160.

The liquid crystal panel for the B component 130B, on which the light having passed through the relay lenses 142, 144, and 146 and having been converted into parallelized light is incident, functions as a light modulation device (light modulator), and the transmittance (transmission rate, modulation rate) thereof is changed based on image information on the B component. Therefore, the light incident on the liquid crystal panel for the B component 130B (third color component light) is modulated based on the image information on the B component having been corrected by the luminance/chromaticity adjuster 180, and the modulated light is incident on the cross dichroic prism 160.

The liquid crystal panel for the R component 130R, the liquid crystal panel for the G component 130G, and the liquid crystal panel for the B component 130B have the same configuration. Each of the liquid crystal panels encapsulates and seals liquid crystal molecules, an electro-optic material, between a pair of transparent glass substrates. For example, a polysilicon thin-film transistor is used as a switching device to modulate the transmission rate of the corresponding color light in accordance with image information associated with each pixel.

The cross dichroic prism 160 has a function of combining the light fluxes incident from the liquid crystal panel for the R component 130R, the liquid crystal panel for the G component 130G, and the liquid crystal panel for the B component 130B and outputting the combined light as exiting light.

The optical filter FL is detachably provided in the optical path of the combined light (exiting light) from the cross dichroic prism 160 between the cross dichroic prism 160 and the projection lens 170. That is, the optical filter FL can be disposed in the optical path of the combined light from the cross dichroic prism 160, whereas disposed in a position outside the optical path of the combined light from the cross dichroic prism 160. The optical filter FL is, for example, a filter that removes (reflects or absorbs) the light having wavelength bands from ultraviolet to 440 nm and from 550 to 630 nm.

When the optical filter FL is disposed in the optical path of the combined light from the cross dichroic prism 160 (when the optical filter FL is attached), the combined light from the cross dichroic prism 160 is incident on the optical filter FL. The optical filter FL reflects the light having predetermined spectral components whereas transmitting the light having the remaining spectral components as described above. The light having passed through the optical filter FL is incident on the projection lens 170.

On the other hand, when the optical filter FL is disposed in a position outside the optical path of the combined light from the cross dichroic prism 160 (when the optical filter FL is detached), the combined light from the cross dichroic prism 160 does not pass through the optical filter FL but is directly incident on the projection lens 170.

The projection lens 170 focuses the combined light directly from the cross dichroic prism 160 or the combined light having passed through the optical filter FL into an enlarged output image on the screen SCR. The projection lens 170 has a function of enlarging or shrinking the image in accordance with a zoom magnification factor.

In the thus configured projection unit 100, a moving mechanism (not shown) moves the optical filter FL into the optical path of the light flux described above or to a position outside the optical path. For example, the optical filter FL is disposed in the optical axis of the projection lens 170 in such a way that the optical filter FL is substantially perpendicular to the optical axis, and the moving mechanism (not shown) can translate the optical filter FL out of the optical path. Conversely, the moving mechanism can translate the optical filter FL located in a position outside the optical path into the optical path in such a way that the optical filter FL is substantially perpendicular to the optical axis of the projection lens 170.

The moving mechanism for moving the optical filter FL described above may be a mechanism manually operated or a mechanism controlled by control information from the image adjustment apparatus 200 or the projector PJ.

The thus configured projector adjustment system 10 adjusts the quality of an image formed by the projector PJ in the following manner:

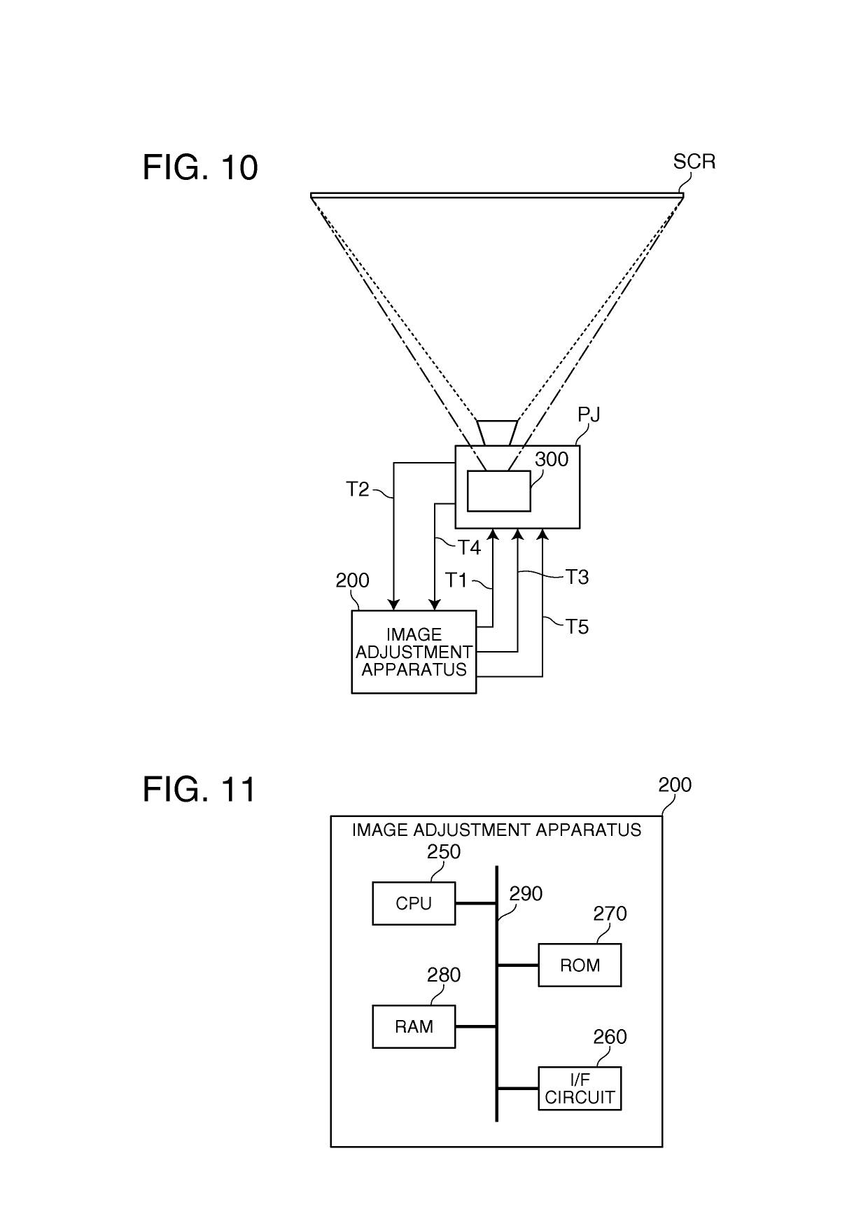

FIG. 10 describes the operation of the projector adjustment system 10 in the first embodiment. In FIG. 10, the portions that are the same as those in FIG. 3 have the same reference characters, and no description of these portions will be made as appropriate.

In the projector adjustment system 10, the image adjustment apparatus 200 first outputs image information corresponding to a predetermined test image to the projector PJ (T1), and the projector PJ projects the test image with the optical filter FL described above detached (first projected image). The test image can be, for example, an image with pixels of the same grayscale arranged thereacross. The capturing device 300 then captures the image projected by the projector PJ on the screen SCR (first projected image) and sends the captured image data (first captured image data) to the image adjustment apparatus 200 (T2).

In the state in which the optical filter FL is detached as described above, the test image is repeatedly projected and captured, for example, for multiple types of grayscale. In this way, captured image data on the projected image using the light that have not passed through the optical filter FL can be acquired.

Subsequently, the image adjustment apparatus 200 outputs image information corresponding to a predetermined test image to the projector PJ (T3), and the projector PJ projects the test image with the optical filter FL described above attached (second projected image). The test image is the same as the test image used when the optical filter FL is detached. That is, the image information corresponding to the projected image using the light that has passed through the optical filter FL is the same as the image information corresponding to the projected image using the light that has not passed through the optical filter FL. The capturing device 300 then captures the image projected by the projector PJ on the screen SCR (second projected image) and sends the captured image data (second captured image data) to the image adjustment apparatus 200 (T4).

In the state in which the optical filter FL is attached as described above, the test image is repeatedly projected and captured, for example, for multiple types of grayscale.

The image adjustment apparatus 200 then uses a pair of captured image data obtained when the optical filter FL is attached and captured image data obtained when the optical filter FL is detached, for example, for each of the grayscales to calculate adjustment parameters for correcting color unevenness, brightness unevenness, and other individual differences in the projector PJ. The image adjustment apparatus 200 sends an adjustment command containing the adjustment parameters to the projector PJ (T5). The projector PJ, which has received the adjustment command, adjusts the luminance and chromaticity of the entire screen based on the adjustment parameters specified by the adjustment command.

The function of adjusting and controlling the image quality of an image projected by the projector PJ performed by the image adjustment apparatus 200 may be implemented by hardware or software processing.

FIG. 11 is a block diagram showing an exemplary hardware configuration of the image adjustment apparatus 200 in the first embodiment.

The image adjustment apparatus 200 includes a CPU 250, an I/F circuit 260, a read only memory (ROM) 270, a random access memory (RAM) 280, and a bus 290, and the CPU 250, the I/F circuit 260, the ROM 270, and the RAM 280 are electrically connected to one another via the bus 290.

For example, the ROM 270 stores a program that achieves the function of the image adjustment apparatus 200. The CPU 250 reads the program stored in the ROM 270 and performs software processing corresponding to the program to achieve the function of the image adjustment apparatus 200. The RAM 280 is used as a work area where the CPU 250 carries out processes or used as a buffer area for the I/F circuit 260 and the ROM 270. The I/F circuit 260 carries out an output interface process of outputting image information and adjustment parameters to the projector PJ and an input interface process of inputting captured image data from the capturing device 300 in the projector PJ.

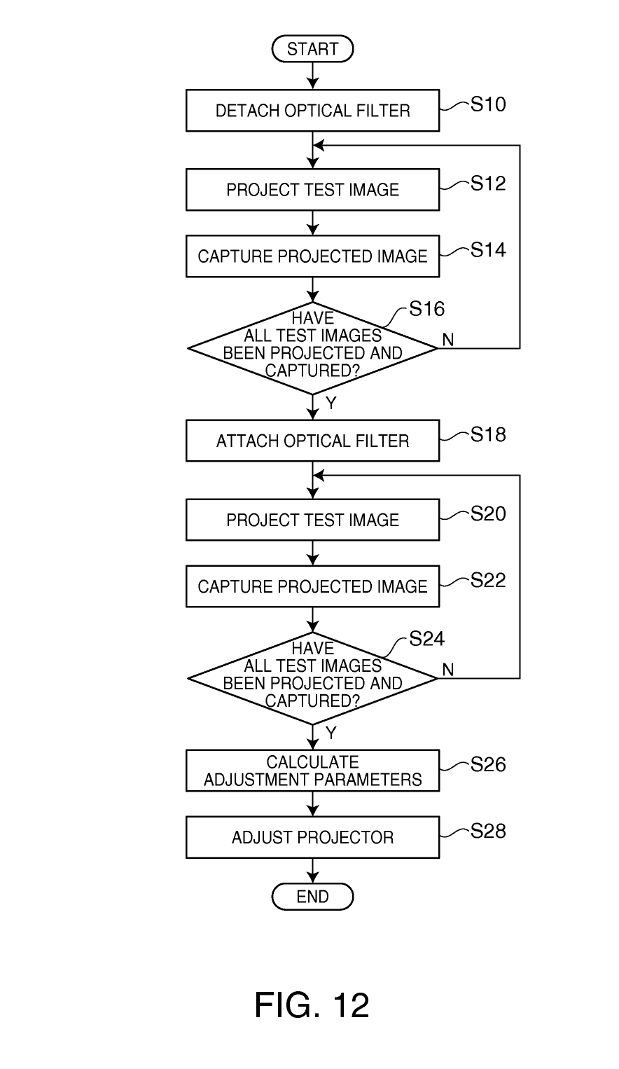

FIG. 12 is a flowchart of exemplary processes carried out by the image adjustment apparatus 200 in the first embodiment. For example, the ROM 270 shown in FIG. 11 stores a program that specifies the process procedure shown in FIG. 12, and the CPU 250 carries out the processes corresponding to the program read from the ROM 270. The functions of the portions that form the image adjustment apparatus 200 can be performed by carrying out the software processes shown in FIG. 12.

First, the image adjustment apparatus 200 carries out a process of detaching the optical filter (step S10). That is, the image adjustment apparatus 200 outputs a command to the projector PJ including the projection unit 100 configured as shown in FIG. 9, and the command controls the projector PJ to dispose the optical filter FL in a position outside the optical path. Alternatively, the image adjustment apparatus 200 outputs a command to the projector PJ to instruct an operator through an operation panel, an indicator lamp, or any other suitable component (not shown) of the projector PJ to dispose the optical filter in a position outside the optical path.

The image adjustment apparatus 200 then produces image information corresponding to a test image in the image information producer 210, sends the image information to the projector PJ, and instructs the projector PJ to project the test image (first projected image) as a first projection step (step S12). In the step S12, the projector PJ, which has received the command from the image adjustment apparatus 200, may project the image, or the operator may be instructed through the operation panel, the indicator lamp, or any other suitable component (not shown) of the projector PJ to project the image.

Subsequently, the image adjustment apparatus 200 sends a command to the projector PJ as a first image capturing step to instruct the capturing device 300 to capture the test image (acquire first captured image data) displayed in the step S12 (step S14).

More specifically, the image adjustment apparatus 200 first outputs to the projector PJ image information on the test image whose grayscales for the G and B components except the R component are “0”, and the capturing device 300 captures the test image corresponding to the image information displayed by the projector PJ on the screen SCR. The image adjustment apparatus 200 then outputs to the projector PJ image information on the test image whose grayscales for the G and B components except the R component are “1”, and the capturing device 300 captures the projected image as described above. The test image is repeatedly displayed and captured until the G and B component grayscales except the R component grayscale reach a maximum value. Similarly, the same procedure described above is repeated for each of the test images corresponding to the R and B component grayscales, except the G component grayscale, from “0” to the maximum value, and then the same procedure is repeated for each of the test images corresponding to the R and G component grayscales, except the B component grayscale, from “0” to the maximum value.

The operations of projecting a test image and capturing the projected image described above are repeated for all the test images (step S16: N). It is desirable that each of the test images is an image with pixels of the same grayscale arranged thereacross and multiple types of test image are prepared for each of the grayscales, as described above.

When the image capturing operation is completed for all the test images with the optical filter FL detached (step S16: Y), the image adjustment apparatus 200 carries out a process of attaching the optical filter (step S18).

In the step S18, the image adjustment apparatus 200 outputs a command to the projector PJ including the projection unit 100 configured as shown in FIG. 9, and the command controls the projector PJ to dispose the optical filter FL in the optical path. Alternatively, the image adjustment apparatus 200 outputs a command to the projector PJ to instruct the operator through the operation panel, the indicator lamp, or any other suitable component (not shown) of the projector PJ to dispose the optical filter in the optical path.

The image adjustment apparatus 200 then produces image information corresponding to a test image in the image information producer 210, sends the image information to the projector PJ, and instructs the projector PJ to project the test image (second projected image) as a second projection step (step S20). In the step S20, the projector PJ, which has received the command from the image adjustment apparatus 200, may project the image, or the operator may be instructed through the operation panel, the indicator lamp, or any other suitable component (not shown) of the projector PJ to project the image.

Subsequently, the image adjustment apparatus 200 sends a command to the projector PJ as a second image capturing step to instruct the capturing device 300 to capture the test image (acquire second captured image data) displayed in the step S20 (step S22).

More specifically, the image adjustment apparatus 200 first outputs to the projector PJ image information on the test image whose grayscales for the G and B components except the R component are “0”, and the capturing device 300 captures the test image corresponding to the image information displayed by the projector PJ on the screen SCR. The image adjustment apparatus 200 then outputs to the projector PJ image information on the test image whose grayscales for the G and B components except the R component are “1”, and the capturing device 300 captures the projected image as described above. The test image is repeatedly displayed and captured until the G and B component grayscales except the R component grayscale reach a maximum value. Similarly, the same procedure described above is repeated for each of the test images corresponding to the R and B component grayscales, except the G component grayscale, from “0” to the maximum value, and then the same procedure is repeated for each of the test images corresponding to the R and G component grayscales, except the B component grayscale, from “0” to the maximum value.

The operations of projecting a test image and capturing the projected image described above are repeated for all the test images (step S24: N). It is desirable that each of the test images is an image with pixels of the same grayscale arranged thereacross and multiple types of test image are prepared for each of the grayscales, as described above.

When the image capturing operation is completed for all the test images with the optical filter FL attached (step S24: Y), the image adjustment apparatus 200 calculates adjustment parameters, as described above, as an adjustment parameter calculation step (step S26). That is, the image adjustment apparatus 200 estimates the spectral distribution associated with the projector PJ in the captured image data analyzer 220 based on the captured image data obtained in the steps S14 and S22 and the spectral sensitivity characteristics of the capturing device 300, converts the estimated spectral distribution into color coordinates in a predetermined color space, and then calculates adjustment parameters in the adjustment parameter calculator 230 based on the converted values. That is, the step S26 includes an estimation step of estimating the spectral characteristics of the projector PJ based on the first captured image data acquired in the step S14, the second captured image data acquired in the step S22, and the spectral sensitivity characteristics of the capturing device 300, and a conversion step of converting the spectral distribution estimated in the estimation step into color coordinates in a predetermined color space, and adjustment parameters are calculated based on the color coordinates obtained in the conversion step. In this way, in the step S26, the captured image data obtained in the step S14 and the captured image data obtained in the step S22, which are captured image data acquired by using a greater number of bands than the number of bands used in the capturing device 300, can be used to calculate the adjustment parameters.

The adjustment parameter calculator 230 determines adjustment parameters as the lightness and color coordinates (L, U, V) in the CIELUV color space of an image projected by the projector PJ, the lightness and color coordinates corresponding to an input value Rin of the R component, an input value Gin of the G component, and an input value Bin of the B component, by modifying the conversion equation shown in FIG. 7 using a conversion matrix defined, for example, in ITU-R (International Telecommunications Union—Radiocommunication Sector) BT. 601. Therefore, the adjustment parameters for providing the lightness and color coordinates may be outputted to the projector PJ.

The image adjustment apparatus 200 then sends a command containing the adjustment parameters calculated in the step S26 to the projector PJ (step S28), and the series of processes described above are terminated (End). The projector PJ, which has received the adjustment parameters from the image adjustment apparatus 200, adjusts the lightness and chromaticity of the entire projected image based on the adjustment parameters.

In FIG. 12, the description has been made with reference to the case where a test image is captured with the optical filter FL detached and then the test image is captured with the optical filter FL attached, but the invention is not limited thereto. For example, a test image may first be captured with the optical filter FL attached, and the test image may then be captured with the optical filter FL detached.

As described above, according to the first embodiment, it is not necessary to prepare an expensive multiband capturing device, but the number of bands can be increased at a low cost in multiband measurement. Further, since it is not necessary to provide any optical filter on the capturing device side, the capturing device will not be displaced due to an optical filter attaching operation, and the mechanism for attaching the capturing device can be simplified.

Moreover, when an optical filter is provided on the side of the capturing device, the thickness of the optical filter causes slight refraction, sometimes resulting in a discrepancy, for example, by approximately several pixels between an image captured with the optical filter detached and an image captured with the optical filter attached. In contrast, according to the first embodiment, since an optical filter that allows the number of bands to be virtually increased in multiband measurement is provided in the projector PJ, the slight refraction resulting from the thickness of the optical filter can be ignored by providing a light stop in the projector PJ. Therefore, no discrepancy in image position will occur between the state in which the optical filter is attached and the state in which the optical filter is detached, and it is not necessary to consider the refraction resulting from the thickness of the optical filter.

### Second Embodiment

While the first embodiment has been described by assuming that the spectral sensitivity characteristics of the capturing device 300 are known, the spectral sensitivity characteristics of the capturing device 300 are not necessarily known in the invention.

In a second embodiment according to the invention, a spectral distribution estimator corresponding to the spectral distribution estimator 222 shown in FIG. 4 can estimate the spectral distribution associated with the projector PJ even when the spectral sensitivity characteristics of the capturing device 300 are unknown. Since the second embodiment only differs from the first embodiment in terms of the configuration and operation of the spectral distribution estimator, the configuration and operation of the projector adjustment system in the second embodiment that are the same as those in the first embodiment will not be illustrated or described.

The estimation of the spectral distribution associated with a projector PJ2 in the second embodiment is, for example, based on the estimation method described in Reference Literature 2 (Francis Schmitt, Hans Brettel, Jon Yngve Hardeberg, “Multispectral Imaging Development at ENST”, Display and Imaging 8, 2000, pp. 261-268). The Reference Literature 2 describes a method for estimating the spectral reflectance of an imaged object whose spectral reflectance is unknown when the spectral sensitivity characteristics of the capturing device 300 is unknown. In the method, the spectral reflectance is estimated by measuring a subject whose spectral reflectance is known (Munsell chroma) under illumination whose spectral distribution is known to calculate the spectral sensitivity characteristics of the capturing device. Therefore, as in the first embodiment, captured image data obtained under a predetermined condition by multiband measurement using a small number of bands can be used to estimate the spectral distribution associated with the projector obtained when the light from the projector is reflected off a screen.

As described above, in the second embodiment, the spectral characteristics of the projector is estimated based on captured image data on an image projected by the projector using the light that has not passed through an optical filter and captured image data on an image projected by the projector using the light that has passed through the optical filter, and the estimated spectral distribution is converted into color coordinates in a predetermined color space. Thereafter, the thus produced conversion information is used to calculate adjustment parameters. That is, in the second embodiment, an adjustment parameter calculation step in FIG. 12 includes an estimation step of estimating the spectral characteristics of the projector PJ based on the first captured image data acquired in the step S14 and the second captured image data acquired in the step S22 and a conversion step of converting the spectral distribution estimated in the estimation step into color coordinates in a predetermined color space, and adjustment parameters are calculated based on the color coordinates obtained in the conversion step.

The second embodiment described above can also provide the same advantage as that provided in the first embodiment.

### Third Embodiment

While the optical filter FL is detachably provided between the cross dichroic prism 160 and the projection lens 170 in the first or second embodiment, the invention is not limited to the arrangement described above.

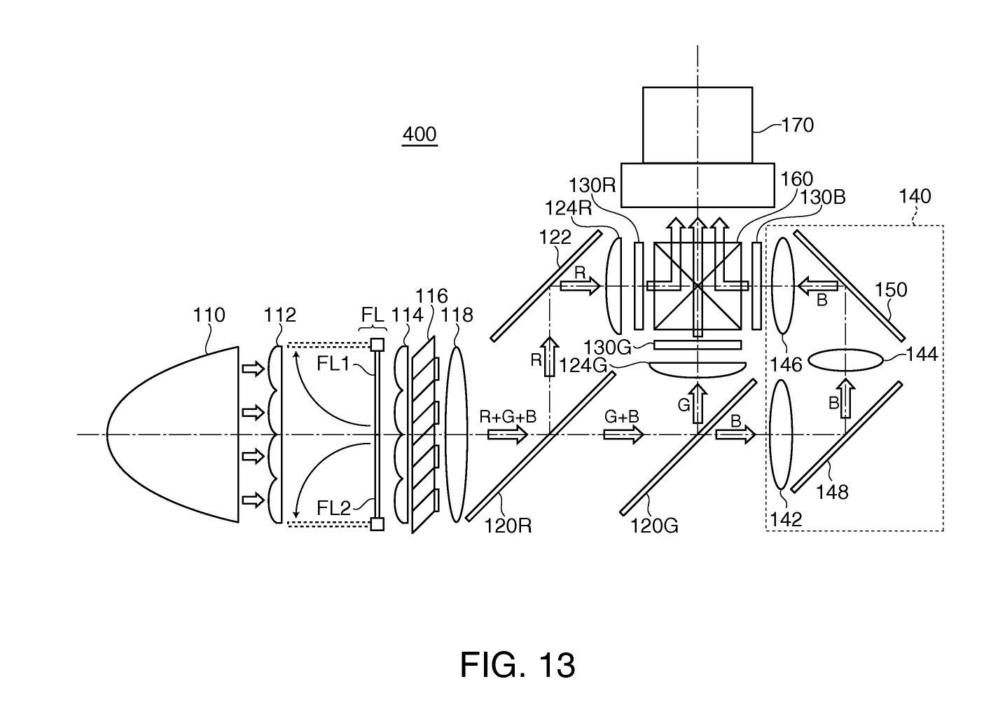

FIG. 13 shows an exemplary configuration of a projection unit 400 in a third embodiment according to the invention. In FIG. 13, the portions that are the same as those in FIG. 9 have the same reference characters, and no description of these portions will be made as appropriate.

The configuration of the projection unit 400 in the third embodiment differs from the configuration of the projection unit 100 shown in FIG. 9 in terms of the position of the optical filter FL detachably disposed in the optical path. That is, the optical filter FL is detachably provided between the light source 110 and the color separation system. In FIG. 13, the optical filter FL is detachably provided between the integrator lens 112 and the integrator lens 114. That is, the optical filter FL can be disposed in the optical path in a position downstream of the integrator lens 112 or a position outside the optical path.

When the optical filter FL is disposed in the optical path in a position downstream of the integrator lens 112 (when the optical filter FL is attached), the light having exited through the integrator lens 112 is incident on the optical filter FL. The optical filter FL removes (reflects) the light containing predetermined spectral components whereas transmitting the light containing the remaining spectral components, as described above. The light having passed through the optical filter FL is incident on the integrator lens 114.

On the other hand, when the optical filter FL is not disposed in the optical path in any position downstream of the integrator lens 112 (when the optical filter FL is detached), the light having exited through the integrator lens 112 does not pass through the optical filter FL but is directly incident on the integrator lens 114.

The optical filter FL in this case is formed of two optical filter pieces FL1 and FL2 obtained by splitting the optical filter FL at the center, and a moving mechanism (not shown) opens and closes the optical filter pieces FL1 and FL2 like bi-parting doors by turning each of the optical filter pieces FL1 and FL2 around the corresponding one of both ends of the optical filter FL.

The mechanism for moving the optical filter FL described above may be a mechanism manually operated or a mechanism controlled by control information from the image adjustment apparatus 200 or the projector PJ.

In the third embodiment, the optical filter FL is not necessarily divided into two, but an undivided optical filter may be used as in the first or second embodiment.

The projection unit 400 in the third embodiment can be used in the projector PJ in place of the projection unit 100 shown in FIG. 3.

The third embodiment described above can provide the same advantage as that provided in the first or second embodiment.

### Fourth Embodiment

While the optical filter FL is detachably provided between the cross dichroic prism 160 and the projection lens 170 in the first and second embodiments or between the light source 110 and the color separation system in the third embodiment, the invention is not limited to the arrangements described above.

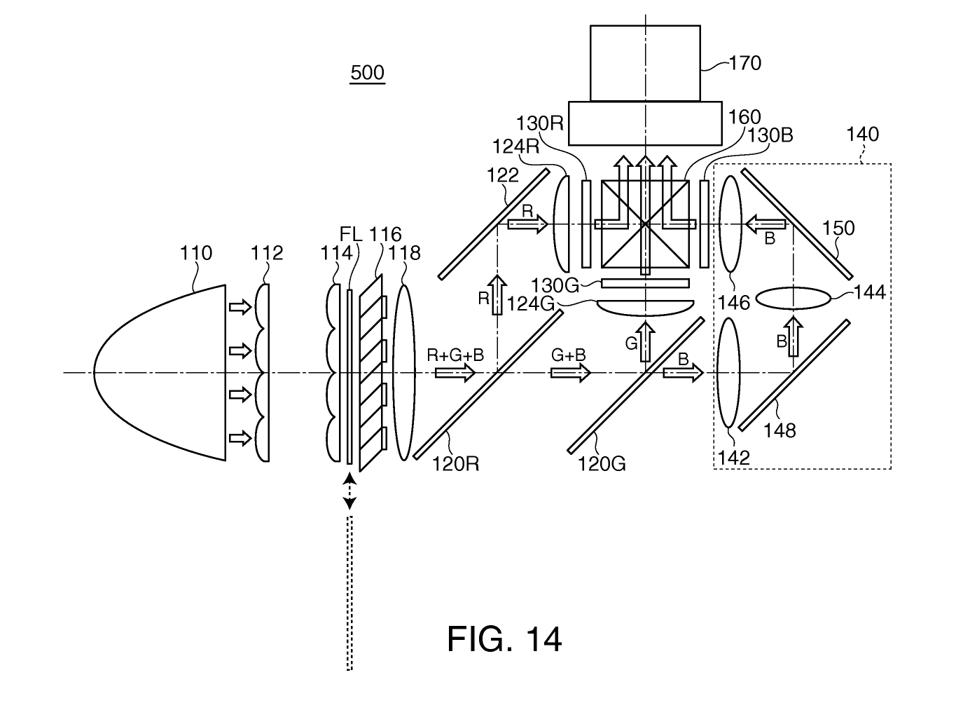

FIG. 14 shows an exemplary configuration of a projection unit 500 in a fourth embodiment according to the invention. In FIG. 14, the portions that are the same as those in FIG. 9 have the same reference characters, and no description of these portions will be made as appropriate.

The configuration of the projection unit 500 in the fourth embodiment differs from the configuration of the projection unit 100 shown in FIG. 9 in terms of the position of the optical filter FL detachably disposed in the optical path. In the fourth embodiment, the optical filter FL is detachably provided in the optical path of the light having passed through the integrator lens 114 between the integrator lens 114 and the polarization conversion element 116. That is, the optical filter FL can be disposed in the optical path of the light having passed through the integrator lens 114 or a position outside the optical path of the light having passed through the integrator lens 114.

When the optical filter FL is disposed in the optical path in a position downstream of the integrator lens 114 (when the optical filter FL is attached), the light having exited through the integrator lens 114 is incident on the optical filter FL. The optical filter FL removes (reflects) the light containing predetermined spectral components whereas transmitting the light containing the remaining spectral components, as described above. The light having passed through the optical filter FL is incident on the polarization conversion element 116.

On the other hand, when the optical filter FL is not disposed in the optical path in any position downstream of the integrator lens 114 (when the optical filter FL is detached), the light having exited through the integrator lens 114 does not pass through the optical filter FL but is directly incident on the polarization conversion element 116.

In the thus configured projection unit 500, a moving mechanism (not shown) moves the optical filter FL into the optical path of the light flux described above or to a position outside the optical path. For example, the optical filter FL is disposed in an illumination optical axis of the light source 110 in such a way that the optical filter FL is substantially perpendicular to the illumination optical axis, and the moving mechanism (not shown) can translate the optical filter FL out of the optical path. Conversely, the moving mechanism can translate the optical filter FL located in a position outside the optical path into the optical path in such a way that the optical filter FL is substantially perpendicular to the illumination optical axis of the light source 110.

The mechanism for moving the optical filter FL described above may be a mechanism manually operated or a mechanism controlled by control information from the image adjustment apparatus 200 or the projector PJ.

The projection unit 500 in the fourth embodiment can be used in the projector PJ in place of the projection unit 100 shown in FIG. 3. Further, the position of the optical filter FL is not limited to the position shown in FIG. 13 or 14. The same advantage is provided as long as the optical filter FL is disposed in any position between the light source 110 and the color separation system.

The fourth embodiment described above can provide the same advantage as those provided in the first to third embodiments.

### Fifth Embodiment

While the first to fourth embodiments have been described with reference to the case where the 3-band capturing device 300 can be used to virtually perform 6-band multiband measurement by detachably providing the optical filter FL between the cross dichroic prism 160 and the projection lens 170 or between the light source 110 and the color separation system, the invention is not limited thereto. For example, the optical filter FL may be detachably provided in any of the optical paths of the color separation system that forms the projection unit of the projector PJ.

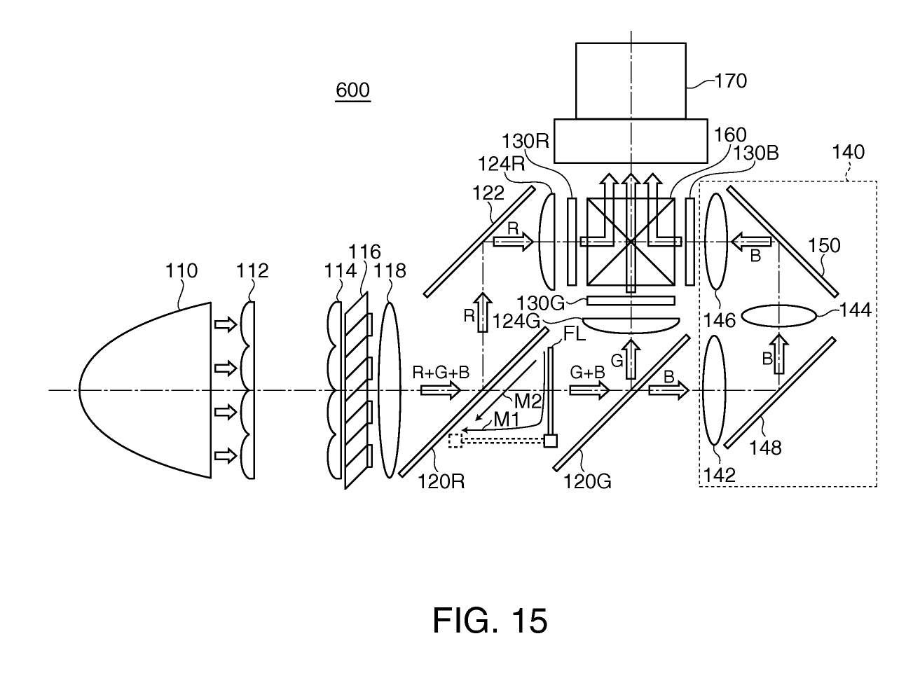

FIG. 15 shows an exemplary configuration of a projection unit 600 in a fifth embodiment according to the invention. In FIG. 15, the portions that are the same as those in FIG. 9 have the same reference characters, and no description of these portions will be made as appropriate.

The configuration of the projection unit 600 in the fifth embodiment differs from the configuration of the projection unit 100 shown in FIG. 9 in terms of the position of the optical filter FL detachably disposed in the optical path. In the fifth embodiment, the optical filter FL is detachably provided in the optical path of the light having passed through the dichroic mirror for the R component 120R between the dichroic mirror for the R component 120R and the dichroic mirror for the G component 120G. That is, the optical filter FL can be disposed in the optical path of the light having passed through the dichroic mirror for the R component 120R or a position outside the optical path of the light having passed through the dichroic mirror for the R component 120R.

When the optical filter FL is disposed in the optical path of the light having passed through the dichroic mirror for the R component 120R (when the optical filter FL is attached), the light having passed through the dichroic mirror for the R component 120R is incident on the optical filter FL. The optical filter FL removes (reflects) the light containing predetermined spectral components whereas transmitting the light containing the remaining spectral components, as described above. The light having passed through the optical filter FL is incident on the dichroic mirror for the G component 120G.

On the other hand, when the optical filter FL is disposed in a position outside the optical path of the light having passed through the dichroic mirror for the R component 120R (when the optical filter FL is detached), the light having passed through the dichroic mirror for the R component 120R does not pass through the optical filter FL but is directly incident on the dichroic mirror for the G component 120G.

In the thus configured projection unit 600, a moving mechanism (not shown) moves the optical filter FL into the optical path of the light flux described above or to a position outside the optical path. For example, the optical filter FL is disposed in the illumination optical axis in such a way that the optical filter FL is substantially perpendicular thereto, and the moving mechanism (not shown) translates the optical filter FL out of the optical path in such a way that one of the two sides of the optical filter FL that are perpendicular to a plane containing the illumination optical axis (the plane corresponding to the plane of view in FIG. 15), the side close to the dichroic mirror for the G component 120G disposed downstream of the optical filter FL in the optical path and far away from the dichroic mirror for the R component 120R disposed upstream of the optical filter FL in the optical path, is moved toward the upstream side of the optical path and the opposite side is positioned on the downstream side of the light path, as indicated by the arrow M1 in FIG. 15.

Alternatively, the moving mechanism may rotate the optical filter FL in such a way that the vicinity of one of the two sides of the optical filter FL that are perpendicular to a plane containing the illumination optical axis (the plane corresponding to the plane of view in FIG. 15), the side close to the dichroic mirror for the G component 120G disposed downstream of the optical filter FL in the optical path and far away from the dichroic mirror for the R component 120R disposed upstream of the optical filter FL in the optical path, is used as an axis to rotate the opposite side, as indicated by the arrow M2 in FIG. 15.

When the optical filter FL is moved by the former mechanism, the space required to move the optical filter FL into the optical path or to a position outside the optical path can be smaller than that required in the case where the latter mechanism is used, whereby the size of the optical system and hence the size of the projector can be reduced. In contrast, when the optical filter FL is moved by the latter mechanism, the configuration of the moving mechanism can be simplified as compared to the case where the former mechanism is used, whereby the manufacturing step can be simplified and the manufacturing cost can be reduced.

The mechanism for moving the optical filter FL described above may be a mechanism manually operated or a mechanism controlled by control information from the image adjustment apparatus 200 or the projector PJ.

The projection unit 600 in the fifth embodiment can be used in the projector PJ in place of the projection unit 100 shown in FIG. 3.

According to the fifth embodiment described above, the 3-band capturing device 300 can be used to perform multiband measurement with the number of bands greater than three, although measurement precision is slightly lower than that provided in the first to fourth embodiments because the number of bands is smaller. As a result, it is not necessary to prepare an expensive multiband capturing device, but the number of bands can be increased at a low cost in multiband measurement, as in the first to fourth embodiments. Further, since it is not necessary to provide any optical filter on the side of the capturing device, the capturing device will not be displaced due to an optical filter attaching operation, and the mechanism for attaching the capturing device can be simplified. Moreover, no discrepancy in image position will occur between the state in which the optical filter is attached and the state in which the optical filter is detached, and it is not necessary to consider the refraction resulting from the thickness of the optical filter.

### Sixth Embodiment

While the optical filter FL is detachably provided between the dichroic mirror for the R component 120R and the dichroic mirror for the G component 120G in the fifth embodiment, the invention is not limited to the arrangement described above.

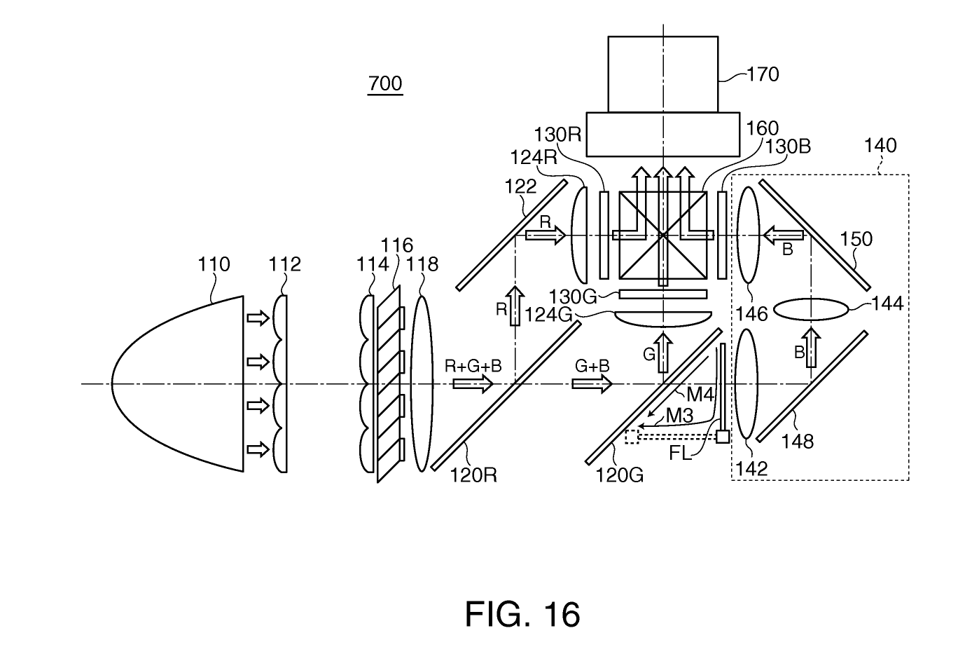

FIG. 16 shows an exemplary configuration of a projection unit 700 in a sixth embodiment according to the invention. In FIG. 16, the portions that are the same as those in FIG. 9 have the same reference characters, and no description of these portions will be made as appropriate.

The configuration of the projection unit 700 in the sixth embodiment differs from the configuration of the projection unit 100 shown in FIG. 9 in terms of the position of the optical filter FL detachably disposed in the optical path. In the sixth embodiment, the optical filter FL is detachably provided in the optical path of the light having passed through the dichroic mirror for the G component 120G between the dichroic mirror for the G component 120G and the relay lens 142. That is, the optical filter FL can be disposed in the optical path of the light having passed through the dichroic mirror for the G component 120G or a position outside the optical path of the light having passed through the dichroic mirror for the G component 120G.

When the optical filter FL is disposed in the optical path of the light having passed through the dichroic mirror for the G component 120G (when the optical filter FL is attached), the light having passed through the dichroic mirror for the G component 120G is incident on the optical filter FL. The optical filter FL removes (reflects) the light containing predetermined spectral components whereas transmitting the light containing the remaining spectral components, as described above. The light having passed through the optical filter FL is incident on the relay lens 142.

On the other hand, when the optical filter FL is disposed in a position outside the optical path of the light having passed through the dichroic mirror for the G component 120G (when the optical filter FL is detached), the light having passed through the dichroic mirror for the G component 120G does not pass through the optical filter FL but is directly incident on the relay lens 142.

In the thus configured projection unit 700, a moving mechanism (not shown) moves the optical filter FL into the optical path of the light flux described above or to a position outside the optical path. For example, the optical filter FL is disposed in the illumination optical axis in such a way that the optical filter FL is substantially perpendicular thereto, and the moving mechanism (not shown) translates the optical filter FL out of the optical path in such a way that one of the two sides of the optical filter FL that are perpendicular to a plane containing the illumination optical axis (the plane corresponding to the plane of view in FIG. 16), the side close to the relay lens 142 disposed downstream of the optical filter FL in the optical path and far away from the dichroic mirror for the G component 120G disposed upstream of the optical filter FL in the optical path, is moved toward the upstream side of the optical path and the opposite side is positioned on the downstream side of the optical path, as indicated by the arrow M3 in FIG. 16.

Alternatively, the moving mechanism may rotate the optical filter FL in such a way that the vicinity of one of the two sides of the optical filter FL that are perpendicular to a plane containing the illumination optical axis (the plane corresponding to the plane of view in FIG. 16), the side close to the relay lens 142 disposed downstream of the optical filter FL in the optical path and far away from the dichroic mirror for the G component 120G disposed upstream of the optical filter FL in the optical path, is used as an axis to rotate the opposite side, as indicated by the arrow M4 in FIG. 16.

When the optical filter FL is moved by the former mechanism, the space required to move the optical filter FL into the optical path or to a position outside the optical path can be smaller than that required in the case where the latter mechanism is used, whereby the size of the optical system and hence the size of the projector can be reduced. In contrast, when the optical filter FL is moved by the latter mechanism, the configuration of the moving mechanism can be simplified as compared to the case where the former mechanism is used, whereby the manufacturing step can be simplified and the manufacturing cost can be reduced.

The mechanism for moving the optical filter FL described above may be a mechanism manually operated or a mechanism controlled by control information from the image adjustment apparatus 200 or the projector PJ.

The projection unit 700 in the sixth embodiment can be used in the projector PJ in place of the projection unit 100 shown in FIG. 3.

The sixth embodiment can provide the same advantage as that provided in the fifth embodiment.

### Seventh Embodiment

The first to sixth embodiments have been described with reference to the case where the optical filter FL is detachably provided in the optical path between the light source 110 and the projection lens 170, the invention is not limited thereto. In a seventh embodiment according to the invention, the optical filter FL is detachably disposed in front of the light-exiting surface of the projection lens of the projector PJ.

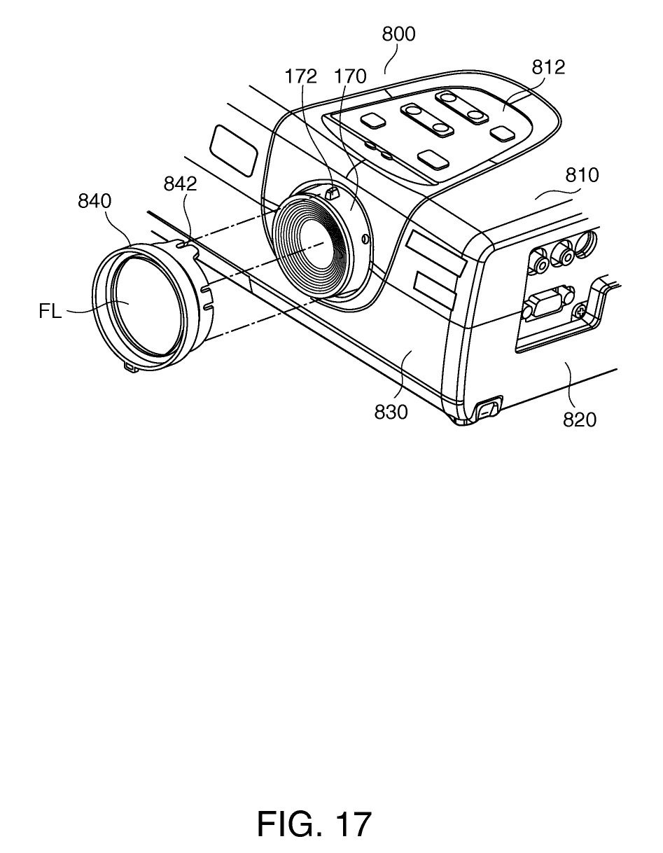

FIG. 17 is an exemplary perspective view showing an exterior key portion of the projector PJ in the seventh embodiment according to the invention. FIG. 17 is a perspective view of the projector PJ viewed from the front but obliquely downward. In FIG. 17, the portions that are the same as those in FIG. 9 have the same reference characters, and no description of these portions will be made as appropriate.

A housing 800 that houses the portions that form the projector PJ includes an upper case 810 that forms an upper portion of the housing 800, a lower case 820 that forms a lower portion of the housing 800, and a front case 830 that forms a front portion of the housing 800. An operation panel 812 is provided on the top surface of the upper case 810, and buttons and other components for activating, adjusting, and otherwise operating the projector PJ are arranged on the operation panel 812. An opening is provided in the front case 830, and a front portion of the projection lens 170 is exposed to the outside through the opening. A focus operation using the projection lens 170 can be manually carried out by rotating a lever 172, which is part of the exposed portion, and the optical filter FL can be attached to the front end of the projection lens 170.

A cylindrical holding member 840 holds the outer circumference of the optical filter FL, and the holding member 840 fits on a front end portion of the projection lens 170, which is the light flux-exiting side of the projection lens 170. More specifically, a cutout 842 is formed as an engaging portion in an end portion of the holding member 840 on the side facing the projection lens 170. When the lever 172 on the projection lens 170 is inserted into the cutout 842, the lever 172 engages the cutout 842, and the axis of the holding member 840 coincides with the optical axis of the projection lens 170.

As described above, the state in which the optical filter FL is attached and the state in which the optical filter FL is detached can be readily achieved in the projector in the seventh embodiment, and the projector configured as shown in FIG. 17 can be used as the projector PJ shown in FIG. 3.

According to the seventh embodiment, the 3-band capturing device 300 can be used to virtually perform 6-band multiband measurement, as in the first to third embodiments. The configuration of the projector PJ can be significantly simplified in the seventh embodiment as compared to the first to third embodiments, whereby precise multiband measurement can be performed at a lower cost.

While several types of projector adjustment method, projector, and projector adjustment system have been described above with reference to the above embodiments of the invention, the invention is not limited to the embodiments described above, but can be implemented in a variety of aspects to the extent that they do not depart from the spirit of the invention. For example, the following variations are possible:

1. While the image adjustment apparatus 200 is provided external to the projector PJ in the embodiments described above, the invention is not limited to this arrangement. For example, the projector PJ may have the function of the image adjustment apparatus 200.

2. While the above embodiments have been described with reference to the case where a projector is adjusted, the invention is not limited thereto. For example, the invention is applicable to a variety of image adjustment systems for adjusting an image formed by a liquid crystal display apparatus, a plasma display apparatus, an organic EL display apparatus, or other similar apparatus.

3. While the above embodiments have been described with reference to the case where a transmissive liquid crystal panel is used as the light modulation device (light modulator), the invention is not limited thereto. The light modulation device (light modulator) may be DLP (Digital Light Processing)®, LCOS (Liquid Crystal On Silicon), or other suitable components.

4. While the above embodiments have been described with reference to the case where the invention relates to a projector adjustment method, a projector, a projector adjustment system, and a projector adjustment program, the invention does not necessarily relate thereto. For example, the invention may relate to a program in which a process procedure for implementing the invention is written and a recording medium on which the program is recorded.

The entire disclosure of Japanese Patent Application No. 2009-050329, filed Mar. 4, 2009 is expressly incorporated by reference herein.

What is claimed is:

1. A method for adjusting a projector that modulates a plurality of types of color light based on image information to project an image, the method comprising:
acquiring first captured image data by using a capturing device to capture a first projected image projected with an optical filter that removes predetermined spectral components not disposed in an optical path inside or outside the projector;
acquiring second captured image data by using the capturing device to capture a second projected image projected with the optical filter disposed in the optical path;
calculating an adjustment parameter for adjusting the projector based on the first and second captured image data; and
adjusting the projector based on the adjustment parameter calculated in the adjustment parameter calculation.

2. The method for adjusting a projector according to claim 1,
wherein the adjustment parameter is calculated in the adjustment parameter calculation, provided that the first and second captured image data are acquired by using bands the number of which is greater than the number of bands used in the capturing device.

3. The method for adjusting a projector according to claim 1,
wherein the adjustment parameter calculation includes
estimating the spectral distribution associated with the projector based on the first and second captured image data and the spectral sensitivity characteristics of the capturing device, and
converting the spectral distribution estimated in the estimation into color coordinates in a predetermined color space, and
the adjustment parameter is calculated based on the color coordinates obtained in the conversion.

4. The method for adjusting a projector according to claim 1,
wherein the adjustment parameter calculation includes
estimating the spectral distribution associated with the projector based on the first and second captured image data, and
converting the spectral distribution estimated in the estimation into color coordinates in a predetermined color space, and
the adjustment parameter is calculated based on the color coordinates obtained in the conversion.

5. The method for adjusting a projector according to claim 1,
wherein the image information corresponding to the first projected image is the same as the image information corresponding to the second projected image.

6. The method for adjusting a projector according to claim 1,
wherein at least one of the luminance and chromaticity of the entire projected image is adjusted in the adjustment of the projector based on the adjustment parameter.

7. A projector that modulates a plurality of types of color light based on image information to project an image, the projector comprising:
a projection unit including a light source, a light modulation device that modulates the plurality of types of color light contained in the light flux emitted from the light source based on the image information, and a projection lens that projects the light modulated by the light modulation device;
an optical filter detachably provided in an optical path inside or outside the projection unit, the optical filter removing predetermined spectral components; and
a capturing device that captures an image projected by the projection unit,
wherein the capturing device acquires first captured image data by capturing a first projected image projected with the optical filter not disposed in the optical path inside or outside the projection unit and acquires second captured image data by capturing a second projected image projected with the optical filter disposed in the optical path.

8. The projector according to claim 7,
wherein at least one of the luminance and chromaticity of the entire projected image is adjusted based on the first and second captured image data.

9. A projector adjustment system for adjusting a projector that modulates a plurality of types of color light based on image information to project an image, the system comprising:
the projector according to claim 7; and
an image adjustment apparatus that adjusts an image projected by the projector,
wherein the image adjustment apparatus includes
a captured image data analyzer that analyzes the first and second captured image data, and
an adjustment parameter calculator that calculates an adjustment parameter for adjusting the projector based on the analysis result obtained from the captured image data analyzer, and
the image projected by the projector is adjusted based on the adjustment parameter.

10. The projector adjustment system according to claim 9,
wherein the adjustment parameter calculator calculates the adjustment parameter, provided that the first and second captured image data are acquired by using bands the number of which is greater than the number of bands used in the capturing device.

11. The projector adjustment system according to claim 9,
wherein the captured image data analyzer estimates the spectral distribution associated with the projector based on the first and second captured image data and the spectral sensitivity characteristics of the capturing device, and converts the estimated spectral distribution into color coordinates in a predetermined color space, and
the adjustment parameter calculator calculates the adjustment parameter based on the color coordinates converted by the captured image data analyzer.

12. The projector adjustment system according to claim 9,
wherein the captured image data analyzer estimates the spectral distribution associated with the projector based on the first and second captured image data, and converts the estimated spectral distribution into color coordinates in a predetermined color space, and
the adjustment parameter calculator calculates the adjustment parameter based on the color coordinates converted by the captured image data analyzer.

13. The projector adjustment system according to claim 9,
wherein the image information corresponding to the image projected by using the light that has passed through the optical filter is the same as the image information corresponding to the image projected by using the light that has not passed through the optical filter.

14. The projector adjustment system according to claim 9,
the projector adjusts at least one of the luminance and chromaticity of the entire projected image based on the adjustment parameter.
